(19) United States
(12) Patent Application Publication
(10) Pub. No.: US 2006/0015681 A1
(43) Pub. Date: Jan. 19, 2006

(54) Apparatus and method for writing and reading data

(75) Inventor: Young-Joon Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/182,822

(22) Filed: Jul. 18, 2005

(30) Foreign Application Priority Data
Jul. 19, 2004 (KR) 10-2004-0056014

(51) Int. Cl. G06F 12/00

(52) U.S. Cl. 711/112

(57) ABSTRACT

Provided is an apparatus and method for writing and reading data. The apparatus for writing and reading data includes an input unit to which data is input, a disc which stores the input data, a disc controller which controls operation of the disc, an output unit which outputs data stored in the disc, and an operation unit which controls operations of the input unit, the disc controller, and the output unit, wherein the disc controller obtains information about an area of the disc in which data can be written, writes data of a file in consecutive positions of the disc using the information about the area of the disc to avoid empty space between files, and reads the data written in the consecutive positions.

### CROSS-REFERENCE TO RELATED APPLICATION

This application claims benefit from Korean Patent Application No. 10-2004-0056014 filed on Jul. 19, 2004 in the Korean Intellectual Property Office, the disclosure of which is incorporated herein by reference in its entirety.

### BACKGROUND OF THE INVENTION

1. Field of the Invention

The present invention relates to an apparatus and method for writing and reading data, and more particularly, to an apparatus and method for writing and reading data, in which high-speed storing and searching of a large amount of data can be performed by writing data of files in consecutive positions of a disc and reading the data written in the consecutive positions to avoid an empty data area between files.

2. Description of the Related Art

Among file systems for storing and searching for data, a file allocation table (FAT) file system has come into widespread use and has superior compatibility. As shown in FIG. 1, the FAT file system is divided into a data block 130 in which data is stored and an FAT 120 that shows a use state of the data block 130 and connection between data blocks. The data block 130 is managed in units of a cluster 132. The cluster 132 corresponds to items 122, respectively, of the FAT 120. Each file is expressed as a document structure called a directory entry 110. The directory entry 110 includes a file name, a file attribute, information about the time at which a file is created, written, and accessed, a size variable indicating data size, and a start cluster variable indicating a cluster in which a file starts. Information about a next cluster in which the file continues is written in a corresponding item of the FAT 120. As such, the FAT 120 is divided into units of a cluster, presents the position of data of a file stored in the data block 130 in the form of a connection list, and indicates whether a corresponding cluster is used.

The FAT 120 stores values indicating whether a corresponding data block holds data of a file and whether the data is the end of the file if the data block holds the data. In FIG. 1, “X” indicates that a corresponding cluster is empty and “EOF” indicates that a corresponding cluster holds the end of a file. Other numbers indicate cluster numbers of the data block which is written after the data block corresponding to the current FAT element.

In the FAT file system, a new file is created and data of the created file is written as follows. First, a directory entry corresponding to a new file is assigned. When data of the new file starts to be written, an empty cluster of a data block is searched using an FAT and the empty cluster is assigned to the file. “EOF” is written in an item of the FAT corresponding to the assigned cluster to indicate that the cluster corresponding to the item containing “EOF” is assigned to the file, and data of the file is written in the assigned cluster. At this time, a cluster number of the assigned cluster is written in a start cluster variable of the assigned directory entry to indicate the position of the first (start) cluster of the file.

If the data size of the file is larger than the size of the assigned cluster, another empty cluster is assigned to the file, a number of the assigned another cluster is written in the item of the FAT corresponding to the first assigned cluster, and “EOF” is written in an item of the FAT corresponding to the newly assigned cluster. Data whose size is smaller than the size of the last cluster of the file can be written in the last cluster and the data size of the file is written in a size variable of the assigned directory entry.

A file can be read from the FAT file system as follows. A directory entry of a file of interest is searched using the name of the file. Data having a data size included in the directory entry is read from a start cluster indicated by a start cluster variable of the directory entry to a cluster corresponding to an item of the FAT in which “EOF” is written.

Like most file systems in a general operating system (OS) environment, an FAT file system is a general-purpose file system that expresses both small and large size files and considers data insertion and data size change through file data editing. However, in the case of a multimedia storage device including moving pictures and audio, such as a digital video recorder (DVR) or a personal video recorder (PVR), the amount of data amounts to several giga-bytes (GB) and data is hardly ever edited on a system. In addition, since temporally consecutive data is stored, it is not necessary to consider data fragmentation as in the FAT file system. In the case of FAT32, an FAT size is equal to the size of a disk (partition) divided by 32 kB×4 B (32 bits). If a hard disk size is 80 GB, an FAT of 80 GB/32 kB×4 B=10 MB is required. In the worst-case scenario, a search through 10 MB may be required to search for an empty cluster.

The FAT file system expresses a data chain in the form of a connection list. However, multimedia playback may support fast forward/reverse search modes, a reverse playback mode, and/or frame-based forward/reverse search modes. Since the FAT file system only supports a unidirectional connection list, when a file pointer needs to be moved in a reverse direction from a specific file position by a predetermined offset, a search should be done again from a start cluster of a file. Thus, the FAT file system is not suitable as a file system for storing a large amount of data that requires a bidirectional fast search such as multimedia data. Moreover, when a file is deleted, a data chain of an FAT should be tracked and an item corresponding to a corresponding cluster should also be deleted. As a result, much time is required.

### SUMMARY OF THE INVENTION

Additional aspects and/or advantages of the invention will be set forth in part in the description which follows and, in part, will be apparent from the description, or may be learned by practice of the invention.

The present invention provides an apparatus and method for writing and reading data, in which an FAT is managed for compatibility with an FAT file system and data is written and read without reference to the FAT, thereby performing high-speed storing and searching of data.

The present invention also allows compatibility with a general-purpose FAT file system by managing an FAT without imposing a load on a file system.

The present invention also allows continuous use of a limited-capacity hard disk by overwriting an old written file with a new one when there is no empty area in a data block.

The present invention also allows data to be recovered in the event of an abnormal system shut-down by indicating a currently written file.

The above stated objects as well as other objects, features and advantages, of the present invention will become clear to those skilled in the art upon review of the following description.

According to an aspect of the present invention, there is provided an apparatus for writing and reading data, the apparatus including an input unit to which data is input, a disc which stores the input data, a disc controller which controls operation of the disc, an output unit which outputs data stored in the disc, and an operation unit which controls operations of the input unit, the disc controller, and the output unit, wherein the disc controller obtains information about an area of the disc in which data can be written, writes data of a file in consecutive positions of the disc using the information about the area of the disc to avoid empty space between files, and reads the data written in the consecutive positions.

According to an aspect of the present invention, there is provided a method for writing and reading data, the method including obtaining information about an area of a disc in which data can be written, and managing the disc using the information about the area of the disc, wherein management of the disc is performed by writing data of the file in consecutive positions of the disc to avoid empty space between files and reading the data written in the consecutive positions.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional FAT file system;

FIG. 2 is a block diagram of an apparatus for writing and reading data according to an embodiment of the present invention;

FIG. 3 illustrates a data structure for managing an area of a disc in which data can be written according to an embodiment of the present invention;

FIG. 4 is a flowchart illustrating a process of obtaining variables indicating an area in which data having the data structure shown in FIG. 3 can be written;

FIG. 5 is a flowchart illustrating a process of reading a file according to an embodiment of the present invention;

FIG. 6 is a flowchart illustrating a process of writing a file according to an embodiment of the present invention;

FIG. 7 is a flowchart illustrating a process of overwriting a file according to an embodiment of the present invention;

FIG. 8 is a flowchart illustrating a process of overwriting a file according to another embodiment of the present invention; and

FIG. 9 is a flowchart illustrating a process according to an embodiment of the present invention when writing of a file is terminated abnormally.

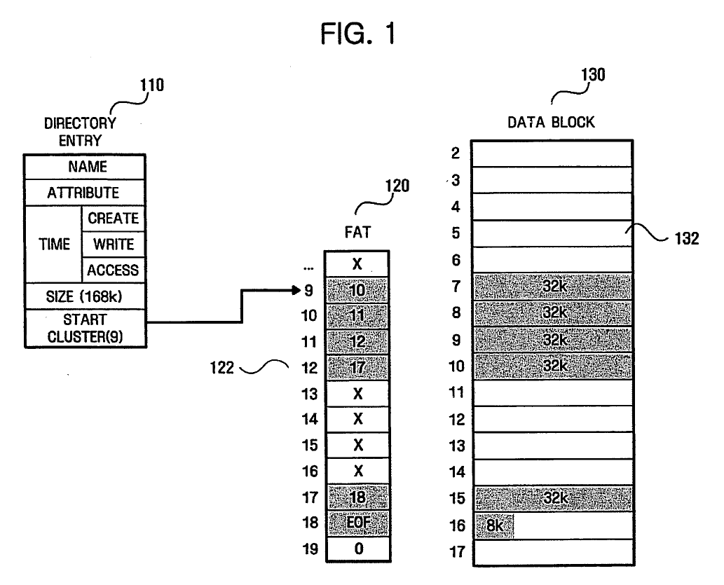

### DETAILED DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Preferred embodiments of the present invention will now be described in detail with reference to the accompanying drawings.

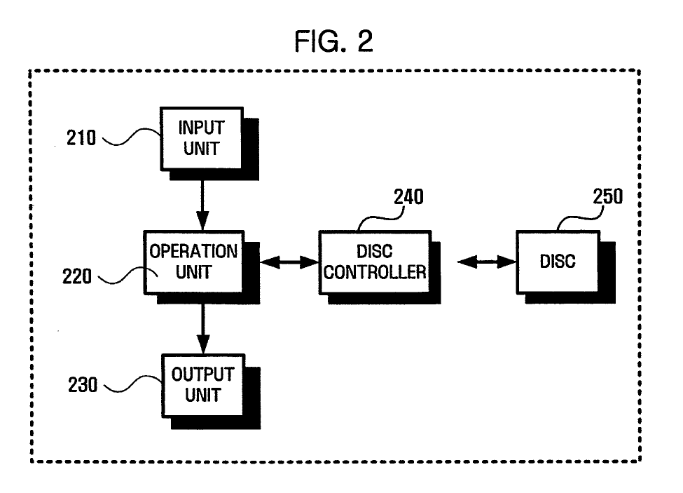

FIG. 2 is a block diagram of an apparatus for writing and reading data according to an embodiment of the present invention.

The apparatus for writing and reading data includes an input unit 210 to which data is input, a disc 250 that stores the input data, a disc controller 240 that controls an operation of the disc 250, an output unit 230 that outputs data read from the disc 250, and an operation unit 220 that controls a basic operation of the apparatus.

The disc controller 240 searches information about an area of a data block of the disc 250 in which data can be written. A detailed description of the search of the information will be made later with reference to FIG. 4. When data is written based on the information about an area in which data can be written, data of a file is written in consecutive positions of a data block of the disc 250 to avoid an empty area between files. When data is read from the disc 250, data written in consecutive positions of a data block is read. Alternatively, if there is no empty area in a data block of the disc 250, the oldest written file may be overwritten. In addition, if the system is abnormally shut down, data may be recovered by setting a specific variable of a currently written file. Detailed descriptions regarding a process in writing, reading, and overwriting of data and abnormal system shut down will be made later with reference to FIGS. 4 through 9.

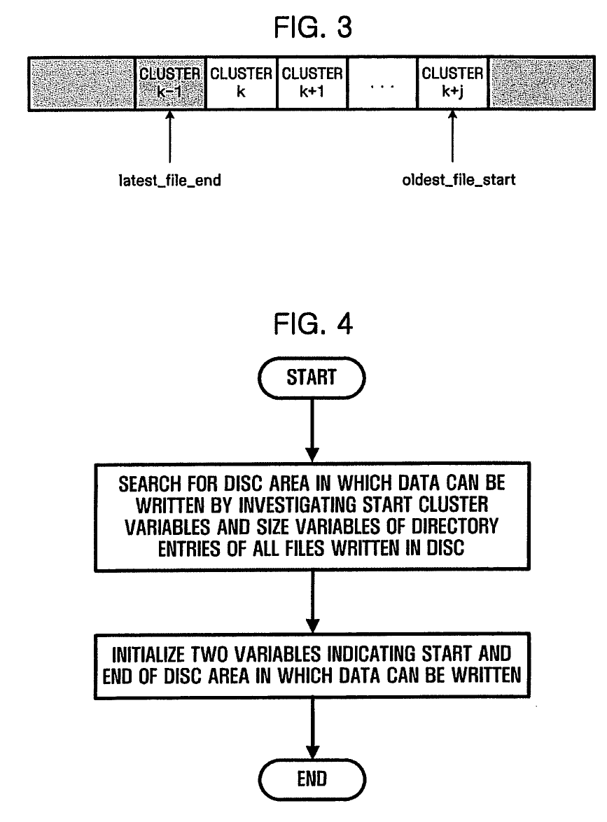

FIG. 3 illustrates a data structure to manage an area of the disc 250 in which data can be written according to an embodiment of the present invention.

Since multimedia data such as moving pictures including audio amounts to several MBs—GBs and can be regarded as temporally consecutive data, a problem of disc fragmentation hardly ever occurs. A file system according to an embodiment of the present invention can manage data blocks of the disc 250 like a circular buffer to store and search data with high speed. In other words, a hard disk is used in a similar manner to a cassette tape of an analog VCR. However, an advantage of the hard disk, i.e., random access, is used to allow high-speed access to a desired position.

To write data of a file in temporally consecutive positions of a data block, a separate data structure to manage the data block may be considered. FIG. 3 illustrates such a data structure according to an embodiment of the present invention in which two variables are used. Here, data is already written in dark areas and data can be written in white areas. A variable latest_file_end has a last cluster number (k−1) of a most recently written file and a variable oldest_file_start has a previous cluster number (k+j) of a start cluster in which an oldest written file starts. Thus, a position of a start cluster of an empty space of a data block in which data can be written can be obtained from the variable latest_file_end and a position of a last cluster of the empty space can be obtained from the variable oldest_file_start. To distinguish cases where all the spaces of a data block are empty and where all the spaces are full of data, at least one cluster should be empty. When data is written, writing starts in a next cluster to a cluster indicated by the variable latest_file_end.

A data structure for managing a data block is not limited to the one shown in FIG. 3, but may take any form needed to express a cluster area to which data can be written. The two variables may have pointer values for clusters instead of cluster numbers. Alternatively, one of the two variables may indicate a start cluster of a space in which data can be written and the other may indicate a next cluster to a last cluster of the space.

To facilitate understanding of the present invention, a description will be made using the data structure shown in FIG. 3.

FIG. 4 is a flowchart illustrating a process of obtaining variables indicating an area in which data having the data structure shown in FIG. 3 can be written.

The variables latest_file_end and oldest_file_start can be obtained by investigating size variables and start cluster variables of directory entries corresponding to all the files written in a disc. As such, since the variables latest_file_end and oldest_file_start can be easily obtained from the directory entries, they are readily available simply by initialization at system booting without being separately stored in the disc. Alternatively, the two variables may be managed without initialization at each system booting by storing them in a separate area of the disc. Alternatively, the two variables may be obtained every time a file operation such as data writing or data searching is performed on a data block.

The variables latest_file_end and oldest_file_start can also be obtained using time information of the directory entries. By investigating creation time or writing time of the directory entries corresponding to all the files written in the disc, the oldest written file and the most recently written file can be found. In this case, there is no need to secure an empty space to obtain the variables latest_file_end and oldest_file_start.

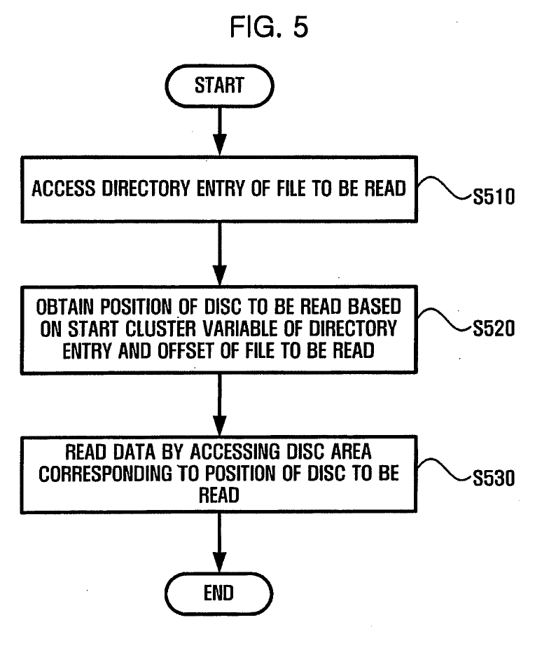

FIG. 5 is a flowchart illustrating a process of reading a file according to an embodiment of the present invention.

A file is read as follows. A directory entry of a file to be read is accessed using the name of the file in operation S510. A position of a disc to be read is obtained using a start cluster variable of the directory entry and an offset value of the file in operation S520. A disc area corresponding to the obtained position is accessed and data is read from the accessed disc area in operation S530.

Since data of a file is consecutively arranged in a disc according to an embodiment of the present invention, access to a random position of the file can be made using a start cluster variable of a directory entry and an offset value of the file without reference to an FAT. Thus, when fast forward/reverse search, reverse playback, or frame-based forward/reverse searching of multimedia data is performed, data at a desired position can be searched rapidly using a start cluster variable of a directory entry of a file and an offset value of the file without a need for repetitive cluster chain tracking.

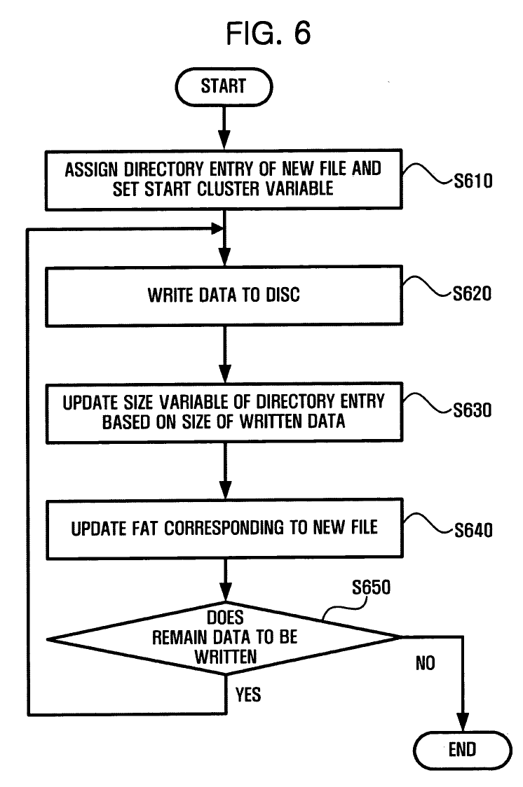

FIG. 6 is a flowchart illustrating a process of writing a file according to an embodiment of the present invention.

To write the file, a directory entry of a new file to be written is assigned and a start cluster variable is set in operation S610. Data is written in a disc in operation S620 and a size variable of the directory entry is updated based on the size of the written data in operation S630. An FAT corresponding to the new file is updated in operation S640. Operations S620 through S640 are repeated until writing of all the data of the new file is completed.

In the operation of setting the start cluster variable (operation S610), the start cluster variable is a number of a next cluster to a cluster indicated by the variable latest_file_end. Thus, every time data is written in a cluster of a disc, the variable latest_file_end circularly is increased by 1 like a variable indicating the end of a circular buffer.

The operation of writing data in the disc (operation S620), the operation of updating the size variable of the directory entry (operation S630), and the operation of updating the FAT (soperation S640) can be repeated for each cluster. However, an FAT in an embodiment of the present invention is not a table referred to for an internal file operation, but is managed for compatibility with an external FAT file system. Thus, in another embodiment of the present invention, data can be written in units of a proper number of clusters and the directory entry and the FAT can be updated in consideration of the system's performance or a process being performed upon an abnormal system shut down. Here, the FAT can be updated at the same time for several clusters because data of a file is written in consecutive clusters and thus a separate operation or tracking regarding connection between clusters is not necessary. Thus, since a value indicating a next cluster number or the end of a file, e.g., “EOF”, is written in each item of an FAT, separate additional work for FAT management can be minimized.

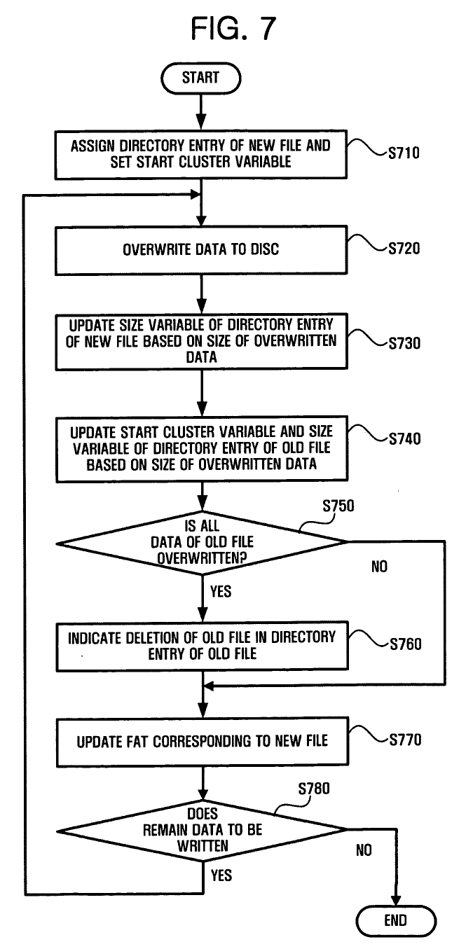

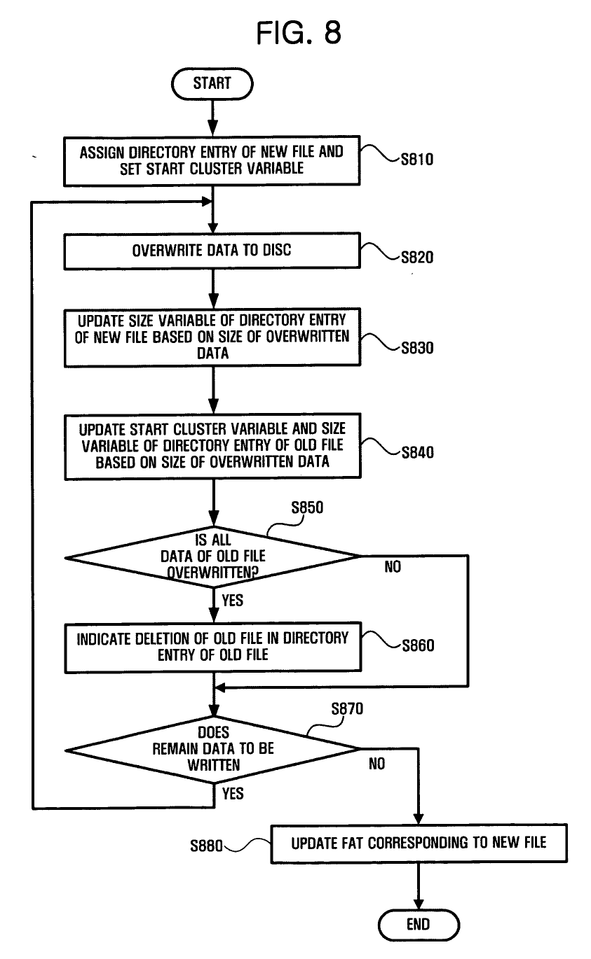

FIGS. 7 and 8 are flowcharts illustrating processes of overwriting a file according to an embodiment of the present invention.

Overwriting involves overwriting a new file in a position where the oldest written file is written without unnecessarily deleting any of the rest of the oldest written file when all the data blocks of a hard disk are full. Overwriting shown in FIG. 7 is performed as follows. A directory entry of a new file is assigned and a start cluster variable is set in operation S710. Data of the new file is written over a disc in operation S720, a size variable and a start cluster variable of the directory entry of the new file are updated in operation S730 based on a size of the overwritten data, and a size variable of a directory entry of an old file in which the new file is overwritten is updated in operation S740 based on the size of the overwritten new data. At this time, if the new file is written over all the data of the old file in operation S750, deletion of the old file is indicated in the directory entry of the old file in operation S760. An FAT corresponding to the new file is updated in step S780. The operation of overwriting data in the disc through the operation of updating the FAT corresponding to the new file (operations S720 through S770) are repeated as long as it is determined that there remains data of the new file to be written in step S780.

A start cluster variable regarding a start cluster where the new file starts can be obtained from the variable oldest_file_start. In other words, data of the new file is written over a start cluster of the oldest written file. Since the variable latest_file_end is smaller than the variable oldest_file_start by 1 when overwriting is performed, the variables latest_file_end and oldest_file_start circularly is increased by 1 every time new data is written in a cluster.

When new data is written over all the data of an old file in operation S750, deletion of the old file is indicated in the directory entry of the old file in operation S760. When new data is written over a portion of all the data of the old file and writing is terminated, a value of an item of an FAT corresponding to a last cluster of the new file is only changed to “EOF” indicating the end of a file. Thus, it is not necessary to perform an additional task such as deletion of an existing file for overwriting, and remaining data of the existing file can be maintained.

Like the data writing described with reference to FIG. 6, the operation of overwriting data in a disc through the operation of updating an FAT (operations S720 through S770) may be repeated in units of a proper number of clusters based on a system's performance, stability, or abnormal shut down, instead of in units of a cluster.

When new data is written over an old file, an FAT may be updated every time data is written, as is the case with general data writing, as shown in FIG. 7. However, since the FAT has been already created at the time of writing an existing file, it may not be separately updated during overwriting as shown in FIG. 8. After the completion of the overwriting in operation S870 without updating the FAT during overwriting, an item indicated by “EOF” among items of the existing FAT is changed to a next cluster number and a value of an item corresponding to a last cluster of a new file is only changed to “EOF” in operation S880. Other operations (operations S810 through S860) are the same as in FIG. 7.

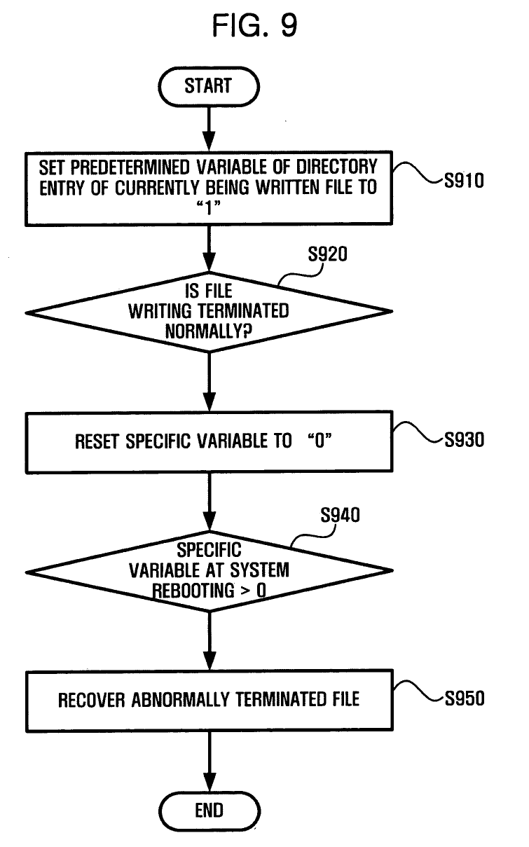

FIG. 9 is a flowchart illustrating a process according to an embodiment of the present invention when writing of a file is terminated abnormally.

A specific variable of a directory entry of a currently written file is set to “1” in operation S910. Once file writing is normally terminated in operation S920, the specific variable is reset to “0” in operation S930. Specific variables of directory entries corresponding to all the files are investigated at system re-booting. If the specific variables are not “0” in operation S940, it can be determined that writing of corresponding files was terminated abnormally. Thus, corresponding recovery is performed in operation S950.

Abnormal termination may be indicated using an existing variable of a directory entry. According to an embodiment of the present invention, a currently written file may be indicated using a specific bit that does not affect other system operations. According to an embodiment of the present invention, a specific bit of an attribute variable of the directory entry indicating an attribute of a file may be used. A bit of the attribute variable may indicate read-only file (R), hidden file (H), system file (S), volume ID (V), directory (D) or archive (A) characteristics. For example, abnormal termination may be indicated using an archive bit of the attribute variable.

Recovery of an abnormally terminated file (operation S950) may change according to an order a file is written. In one embodiment of the present invention, it may be assumed that data writing, directory entry updating, and FAT updating are sequentially performed during file writing. Here, abnormal termination during data writing may be disregarded. In the case of abnormal termination after directory entry updating, protection ranges only up to the finally updated data of the directory entry and a bit indicating abnormal termination of the directory entry is reset after updating an item of an FAT that does not match the directory entry. If the directory entry is terminated abnormally after FAT updating, only a bit indicating abnormal termination of the directory entry is reset.

An apparatus and method for writing and reading data according to the present invention provides at least the following advantages.

First, a file allocation table (FAT) is managed for compatibility with an FAT file system and data is written and read without reference to the FAT, thereby performing high-speed storing and searching of data.

Second, compatibility with a general-purpose FAT file system is achieved by managing an FAT without imposing a load on a file system.

Third, continuous use of a limited-capacity hard disk is allowed by overwriting an old written file with a new one when there is no empty area in a data block.

Fourth, data is recovered through rapid investigation regarding an abnormally terminated file by indicating a currently written file in a directory entry.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for writing and reading data, the apparatus comprising:
an input unit to which data is input;
a disc which stores the input data;
a disc controller which controls operation of the disc;
an output unit which outputs data stored in the disc; and
an operation unit which controls operations of the input unit, the disc controller, and the output unit,
wherein the disc controller obtains information about an area of the disc in which data can be written, writes data of a file in consecutive positions of the disc using the information about the area of the disc to avoid empty space between files, and reads the data written in the consecutive positions.

2. The apparatus of claim 1, wherein the information about the area of the disc includes a value indicating the last portion of a most recently written file and a value indicating the start portion of an oldest written file.

3. The apparatus of claim 1, wherein the information about the area of the disc is obtained using start cluster variables and size variables of directory entries corresponding to all the files stored in the disc.

4. The apparatus of claim 1, wherein the disc controller accesses a directory entry of a file to be read, obtains a position of the disc to be read using a start cluster variable of the directory entry and an offset value of the file to be read, and reads data of the file by accessing a disc area corresponding to the obtained position.

5. The apparatus of claim 1, wherein the disc controller assigns a directory entry of a new file, sets a start cluster variable of the directory entry, writes data of the new file in the disc, updates a size variable of the directory entry based on the size of the written data, and updates an FAT (File Allocation Table) corresponding to the new file.

6. The apparatus of claim 1, wherein the disc controller assigns a directory entry of a new file, sets a start cluster variable of the directory entry, writes data of the new file in the disc, updates a size variable of the directory entry based on the size of the written data, updates a start cluster variable and a size variable of a directory entry of an old file in which the new file is overwritten, indicates deletion of the old file in the directory entry of the old file if the new file is written over all the data of the old file, and updates a FAT(File Allocation Table) corresponding to the new file.

7. The apparatus of claim 1, wherein the disc controller writes information indicating that a file is being written in a directory entry of the currently being written file, resets the information if writing of the file is terminated normally, and recovers the file if the information is written at system rebooting.

8. The apparatus of claim 7, wherein the information indicating that a file is being written is stored in a specific variable of the directory entry.

9. A method for writing and reading data, the method comprising:
obtaining information about an area of a disc in which data can be written; and managing the disc using the information about the area of the disc,
wherein the operation of managing the disc comprises writing data of the file in consecutive positions of the disc to avoid empty space between files

10. The method of claim 9, wherein the information about the area of the disc comprises a value indicating the last portion of a most recently written file and a value indicating the start portion of an oldest written file.

11. The method of claim 9, wherein the information about the area of the disc is obtained using start cluster variables and size variables of directory entries corresponding to all the files stored in the disc.

12. The method of claim 9, wherein the operation of managing the disc comprises:
accessing a directory entry of a file;
obtaining a position of the disc using a start cluster variable of the directory entry and an offset value of the file; and reading data of the file by accessing a disc area corresponding to the obtained position.

13. The method of claim 9, wherein the operation of managing the disc comprises:
assigning a directory entry of a new file and setting a start cluster variable of the directory entry;
writing data of the new file to the disc;
updating a size variable of the directory entry with the size of the written data; and
updating an FAT(File Allocation Table) corresponding to the new file.

14. The method of claim 9, wherein the operation of managing the disc comprises:
assigning a directory entry of a new file and setting a start cluster variable of the directory entry;
writing data of the new file in the disc;
updating a size variable of the directory entry with the size of the written data;
updating a start cluster variable and a size variable of a directory entry of an old file over which the new file is overwritten;
indicating deletion of the old file in the directory entry of the old file if the new file is written over all the data of the old file; and
updating an FAT corresponding to the new file.

15. The method of claim 9, wherein the operation of managing the disc comprises:
writing information indicating that a file is being written in a directory entry of the currently being written file;
resetting the information if writing of the file is terminated normally; and
recovering the file if the information is written at system rebooting.

16. The method of claim 15, wherein the information indicating that the file is being written is stored in a specific variable of the directory entry.

17. A recording medium having a computer readable program recorded therein, the program for executing a method for writing and reading data, the method comprising:
obtaining information about an area of a disc in which data can be written; and
managing the disc using the information about the area of the disc,
wherein the step of managing the disc comprises writing data of the file in consecutive positions of the disc to avoid empty space between files and reading the data written in the consecutive positions.

18. A method for writing and reading data, the method comprising:
setting a predetermined variable of directory entry of currently being written file;
checking whether the file writing terminated normally;
resetting the predetermined variable if the file writing terminated normally; and
checking the predetermined variable and recovering the abnormally terminated file if the predetermined variable is the set value.
